(19) United States
(12) Patent Application Publication
(10) Pub. No.: US 2026/0245418 A1
(43) Pub. Date: Aug. 20, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventor: Hirokazu HAMADA, Tokyo (JP)

(73) Assignee: NEC Corporation, Tokyo (JP)

(21) Appl. No.: 19/473,254

(22) PCT Filed: Apr. 14, 2023
(86) PCT No.: PCT/JP2023/015161

§ 371 Date: Oct. 7, 2025

(51) Int. Cl. G07C 9/15; G06V 40/16; G07C 9/00; G07C 9/25

(52) U.S. Cl. CPC G07C 9/15; G06V 40/172; G07C 9/00563; G07C 9/25

(57) ABSTRACT

An information processing apparatus includes: an image acquisition unit that acquires an image including a facial recognition area, which is set in a ticket gate area of a railway station and through which a user of the railway station passes; a facial recognition unit that performs facial recognition on the user, based on the image; and an information processing unit that registers information for using an automatic ticket gate linked to a registrant corresponding to the user identified by the facial recognition, and information indicating at least one of the user entering the railway station and the user exiting from the railway station, in a system related to the automatic ticket gate.

### TECHNICAL FIELD

The present disclosure relates to technical fields of an information processing apparatus, an information processing method, and a recording medium.

### BACKGROUND ART

As this type of apparatus, for example, there is proposed an apparatus that allows both ticket gate processing using a medium, which is a ticket, and ticket gate processing using facial collation, and that performs the ticket gate processing using the medium or the facial collation on a single passerby (see Patent Literature 1). Other prior art documents related to this disclosure include Patent Literatures 2 and 3.

### CITATION LIST

### Patent Literature

Patent Literature 1: JP2022-144170A

Patent Literature 2: JP2022-048502A

Patent Literature 3: JP2021-149257A

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect includes: an image acquisition unit that acquires an image including a facial recognition area, which is set in a ticket gate area of a railway station and through which a user of the railway station passes; a facial recognition unit that performs facial recognition on the user, based on the image; and an information processing unit that registers information for using an automatic ticket gate linked to a registrant corresponding to the user identified by the facial recognition, and information indicating at least one of the user entering the railway station and the user exiting from the railway station, in a system related to the automatic ticket gate.

An information processing method according to an example aspect includes: acquiring an image including a facial recognition area, which is set in a ticket gate area of a railway station and through which a user of the railway station passes; performing facial recognition on the user, based on the image; and registering information for using an automatic ticket gate linked to a registrant corresponding to the user identified by the facial recognition, and information indicating at least one of the user entering the railway station and the user exiting from the railway station, in a system related to the automatic ticket gate.

A recording medium according to an example aspect is a recording medium on which a computer program that allows a computer to execute an information processing method is recorded, the information processing method including: acquiring an image including a facial recognition area, which is set in a ticket gate area of a railway station and through which a user of the railway station passes; performing facial recognition on the user, based on the image; and registering information for using an automatic ticket gate linked to a registrant corresponding to the user identified by the facial recognition, and information indicating at least one of the user entering the railway station and the user exiting from the railway station, in a system related to the automatic ticket gate.

### BRIEF DESCRIPTION OF DRAWINGS

FIG. 1 is a diagram illustrating an example of a ticket gate system.

FIG. 2 is a diagram illustrating an example of a facial information database.

FIG. 3 is a block diagram illustrating an example of a configuration of an information processing apparatus.

FIG. 4 is a diagram illustrating an example of a ticket gate area at a railway station.

FIG. 5 is a flowchart illustrating operation of the information processing apparatus according to the first example embodiment.

FIG. 6 is a block diagram illustrating another configuration of the information processing apparatus.

FIG. 7 is a diagram for explaining person tracking processing.

FIG. 8 is a diagram illustrating an example of an ID correspondence table.

### DESCRIPTION OF EXAMPLE EMBODIMENTS

### First Example Embodiment

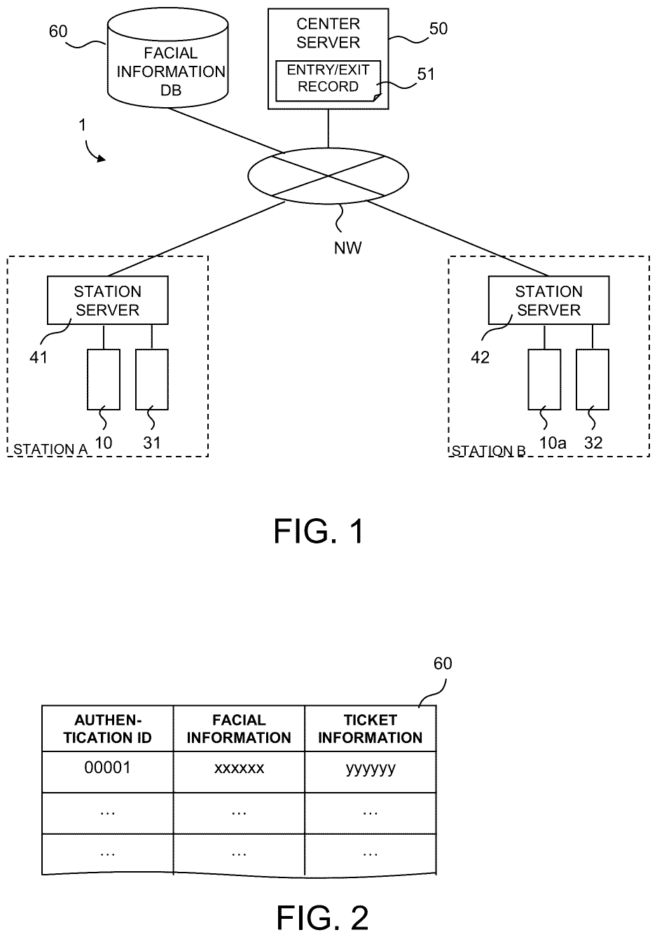

An information processing apparatus, an information processing method, and a recording medium according to a first example embodiment will be described with reference to FIG. 1 to FIG. 5. The following describes the information processing apparatus, the information processing method, and the recording medium according to the first example embodiment, by using an information processing apparatus 10 provided in a ticket gate system 1.

### (Overview of Ticket Gate System)

An overview of the ticket gate system according to the first example embodiment will be described with reference to FIG. 1. In FIG. 1, the ticket gate system 1 includes: a station server 41 installed at a station A, which is a railway station; a station server 42 installed at a station B, which is a railway station; a center server 50; and an information database 60 (hereinafter referred to as “facial information DB 60” as appropriate). The station servers 41 and 42, the center server 50, and the facial information DB 60 are connected via a network NW. The network NW is, for example, a wide area network such as the Internet.

The ticket gate system 1 may include information processing apparatuses 10 and 10a, as well as automatic ticket gates 31 and 32. The information processing apparatus 10 and the automatic ticket gate 31 may be installed at the station A. Note that one of the information processing apparatus 10 and the automatic ticket gate 31 may not be installed at the station A. That is, at least one of the information processing apparatus 10 and the automatic ticket gate 31 may be installed at the station A. The information processing apparatus 10a and the automatic ticket gate 32 may be installed at the station B. Note that one of the information processing apparatus 10a and the automatic ticket gate 32 may not be installed at the station B. That is, at least one of the information processing apparatus 10a and the automatic ticket gate 32 may be installed at the station B.

At the station A, the station server 41, the information processing apparatus 10, and the automatic ticket gate 31 may be connected via a narrow area network such as a local area network (LAN). At the station B, the station server 42, the information processing apparatus 10a, and the automatic ticket gate 32 may be connected via a narrow area network such as a LAN.

The automatic ticket gates 31 and 32 are ticket gate apparatuses for which at least one of magnetic tickets, IC (Integrated Circuit) tickets, and mobile tickets are usable. Since existing various aspects are applicable to the automatic ticket gates 31 and 32, a detailed description of the automatic ticket gates is omitted.

The station server 41 may acquire, from the automatic ticket gate 31, information indicating that a user holding an IC ticket or mobile ticket has entered the station A. In this case, the station server 41 may link identification information related to the IC ticket or mobile ticket, with the information indicating that the user has entered the station A, and may transmit the linked information to the center server 50. The center server 50 may register the information transmitted from the station server 41, in an entry/exit record 51.

The station server 41 may acquire, from the automatic ticket gate 31, information indicating that a user holding an IC ticket or mobile ticket has exited from the station A. In this case, the station server 41 may link identification information about the IC ticket or mobile ticket, with the information indicating that the user has exited from the station A, and may transmit the linked information to the center server 50. The center server 50 may register the information transmitted from the station server 41, in the entry/exit record 51.

The station server 42 may acquire, from the ticket gate apparatus, information indicating that a user holding an IC ticket or mobile ticket has entered the station B. In this case, the station server 42 may link identification information about the IC ticket or mobile ticket, with the information indicating that the user has entered the station B, and may transmit the linked information to the center server 50. The center server 50 may register the information transmitted from the station server 42 in the entry/exit record 51.

The station server 42 may acquire, from the ticket gate apparatus, information indicating that a user holding an IC ticket or mobile ticket has exited from the station B. In this case, the station server 42 may link identification information about the IC ticket or mobile ticket, with the information indicating that the user has exited from the station B, and may transmit the linked information to the center server 50. The center server 50 may register the information transmitted from the station server 42 in the entry/exit record 51.

For example, let us assume that one user enters the station A, travels by train from the station A to the station B, and exits from the station B. In this case, the entry/exit record 51 on the center server 50 may register that the user has entered the station A and has exited from the station B. The center server 50 may calculate railway charges (e.g., fares) from the station A to the station B. The center server 50 may settle the calculated railway charges by using settlement/payment information about the one user. The settlement information may be, for example, at least one of credit card information, debit card information, prepaid card information, IC card information, and account information.

The facial information DB 60 stores information about those wishing to use the ticket gate system 1. Among those wishing to use the ticket gate system 1, a person whose information is registered in the facial information DB 60 is referred to as a “registrant” as appropriate. The facial information DB 60 stores authentication IDs serving as identification information for respectively identifying/distinguishing a plurality of registrants. Information about each of the plurality of registrants is linked to the corresponding authentication ID and is stored in the facial information DB 60.

Here, the facial information DB 60 will be described with reference to FIG. 2. As illustrated in FIG. 2, facial information and ticket information may be linked to the authentication ID of a single registrant. The facial information may be, for example, feature quantities themselves indicating facial features of the single registrant, or information (e.g., a file name) for identifying the feature quantities. Alternatively, the facial information may be, for example, a facial image itself including a face of the single registrant, or information (e.g., a file name) for identifying the facial image. The ticket information is information about at least one of the IC ticket and the mobile ticket usable at automatic ticket gates (e.g., the automatic ticket gates 31 and 32). Therefore, it can be said that the ticket information is information for using the automatic ticket gates (e.g., the automatic ticket gates 31 and 32).

The configuration and operation of the automatic ticket gates 31 and 32, the station servers 41 and 42, and center server 50 may be the same as those of a system related to existing automatic ticket gates. Therefore, it can be said that the ticket gate system 1 is a system including the information processing apparatuses 10 and 10a and the facial information DB 60, in addition to the system related to the existing automatic ticket gates.

### (Information Processing Apparatus)

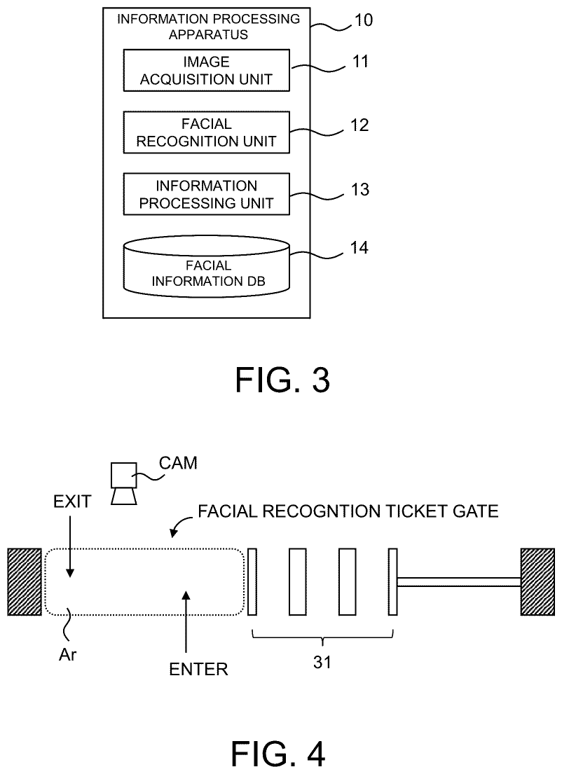

The information processing apparatus 10 will be described with reference to FIG. 3. The information processing apparatus 10a may have a configuration similar to that of the information processing apparatus 10. Therefore, a description of the information processing apparatus 10a is omitted.

The information processing apparatus 10 performs facial recognition on users passing through a ticket gate area of the station A (in other words, subjects to be authenticated, or authentication subjects). The information processing apparatus 10 detects whether a registrant corresponding to a user identified by the facial recognition has entered the station A or has exited from the station A. That is, the information processing apparatus 10 detects entry/exit of users at a railway station (e.g., the station A), as in the automatic ticket gates (e.g., the automatic ticket gates 31 and 32).

In FIG. 3, the information processing apparatus 10 includes an image acquisition unit 11, a facial recognition unit 12, an information processing unit 13, and a facial information database 14 (hereinafter referred to as a “facial information DB 14” as appropriate). Incidentally, the facial information DB 14 may store the same information as that registered in the facial information DB 60. The facial information DB 14 may be updated at predetermined intervals to ensure that the information registered in the facial information DB 14 is the same as that that registered in the facial information DB 60.

Now, with reference to FIG. 4, the ticket gate area of the station A will be described. The ticket gate area includes: a section in which the automatic ticket gate 31 is installed; and a facial recognition ticket gate that is a section in which the entry/exit of users is detected by the information processing apparatus 10. The station A may be provided with two or more automatic ticket gates 31. In FIG. 4, the automatic ticket gate 31 is illustrated adjacent to the facial recognition ticket gate, but the arrangement between the automatic ticket gate 31 and the facial recognition ticket gate is not limited to this configuration.

The facial recognition ticket gate includes a facial recognition area Ar through which at least a part of users of the station A passes. As illustrated in FIG. 4, users entering the station A pass through the facial recognition area Ar from a lower side to an upper side of the drawing. Users exiting from the station A pass through the facial recognition area Ar from the upper part to the lower part of the drawing.

Note that the facial recognition area Ar is a virtual area. Therefore, the station A may not be provided with any drawn marks indicating the facial recognition area Ar or the like. The station A, however, may be provided with the drawn marks indicating the facial recognition area Ar. The facial recognition area through which the users entering the station A pass and the facial recognition area through which the users exiting from the station A pass, may be set separately.

A camera CAM is installed to capture images of the facial recognition area Ar. The camera CAM may not be installed such that the entire facial recognition area Ar is included within its angle of view. In other words, the camera CAM may be installed to capture images of at least a part of the facial recognition area Ar. The camera CAM may be installed at a position that does not obstruct the passage of the users of the station A (e. g., at a position higher than the users' heads).

The camera CAM may be a high-resolution camera, such as a 4K resolution camera. The camera CAM may be connected to the information processing apparatus 10 via a cable or by using a wireless communication technology. Alternatively, the camera CAM may be connected to the station server 41 via a cable or by using the wireless communication technology. The station A may be additionally provided with another camera that is configured to capture images of at least a part of the facial recognition area Ar, in addition to the camera CAM. That is, the station A may be provided with two or more cameras that are configured to capture images of at least a part of the facial recognition area Ar.

Returning to FIG. 3, the image acquisition unit 11 of the information processing apparatus 10 acquires an image including the facial recognition area Ar, which is generated by the camera CAM capturing the facial recognition area Ar. The image acquisition unit 11 may acquire the image directly from the camera CAM or may acquire it from the camera CAM via the station server 41.

The facial recognition unit 12 performs facial recognition, based on the image acquired by the image acquisition unit 11. Note that various existing aspects, such as a two-dimensional (2D) authentication method or three-dimensional (3D) authentication method, may be applicable to the facial recognition. An example of processing related to the facial recognition will be described below.

The facial recognition unit 12 may detect a face of a user included in the image (hereinafter referred to as the “authentication subject”). The facial recognition unit 12 may calculate facial feature quantities indicating the features of the detected face. The facial recognition unit 12 may identify a registrant corresponding to the authentication subject, by using the calculated facial feature quantities and the facial information DB 14.

The facial recognition unit 12 may calculate a matching score from the calculated facial feature quantities (i.e., facial feature quantities related to the face of the authentication subject) and from facial feature quantities based on the facial information on a single registrant registered in the facial information DB 14. In a case where the calculated matching score exceeds a predetermined threshold, the facial recognition unit 12 may determine that the single registrant corresponds to the authentication subject.

In a case where the calculated matching score is less than the predetermined threshold, the facial recognition unit 12 may calculate a matching score from the calculated facial feature quantities and from facial feature quantities based on the facial information on another registrant registered in the facial information DB 14. In this case, the facial recognition unit 12 may determine that the single registrant is not the registrant corresponding to the authentication subject. In a case where the calculated matching score is “equal” to the predetermined threshold, it may be included in one of the cases.

In a case where a registrant corresponding to a user passing through the facial recognition area Ar from the outside toward the inside of the station A is identified, the information processing unit 13 may determine that the registrant has entered the station A. In a case where a registrant corresponding to a user passing through the facial recognition area Ar from the inside toward the outside of the station A is identified, the information processing unit 13 may determine that the registrant has exited from the station A.

In a case where the facial recognition area through which the users entering the station A pass and the facial recognition area through which the users exiting from the station A pass are set separately, the information processing unit 13 may determine that the registrant identified by the facial recognition performed based on the image including the facial recognition area through which the users entering the station A pass is a registrant entering the station A. In this case, the information processing unit 13 may determine that the registrant identified by the facial recognition performed based on the image including the facial recognition area through which the user exiting from the station A passes is a registrant exiting from the station A.

The information processing unit 13 acquires, from the facial information DB 14, the ticket information linked to the authentication ID of the registrant corresponding to the authentication subject (in other words, the user of the station A) identified by the facial recognition unit 12.

In a case where the aforementioned registrant corresponds to the authentication subject having entered the station A, the information processing unit 13 may link the ticket information (e.g., the information about at least one of the IC ticket and the mobile ticket) with information indicating entering the station A and may transmit the linked information to the station server 41. The station server 41 may transmit the ticket information and the information indicating entering the station A, which are transmitted from the information processing unit 13, to the center server 50. As a result, the aforementioned registrant having entered the station A may be registered in the entry/exit record 51.

In a case where the aforementioned registrant corresponds to the authentication subject having exited from the station A, the information processing unit 13 may link the ticket information (e.g., the information about at least one of the IC ticket and the mobile ticket) with information indicating exiting from the station A and may transmit the linked information to the station server 41. The station server 41 may transmit the ticket information and the information indicating exiting from the station A, which are transmitted from the information processing unit 13, to the center server 50. As a result, the aforementioned registrant having exited from the station A may be registered in the entry/exit record 51.

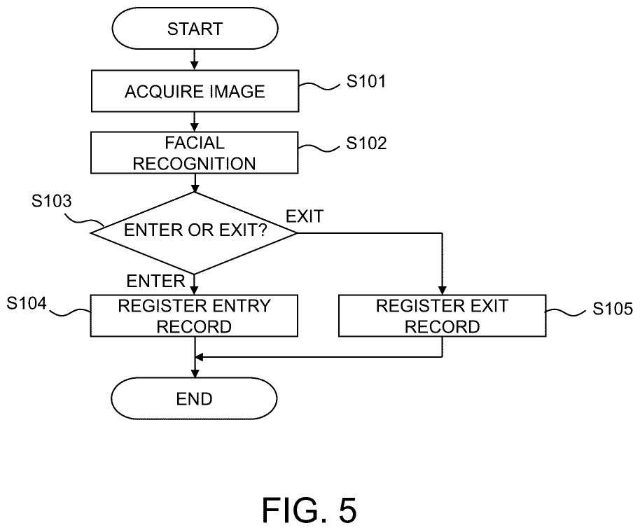

Next, with reference to a flowchart in FIG. 5, the operation of the information processing apparatus 10 will be described. In FIG. 5, the image acquisition unit 11 acquires the image including the facial recognition area Ar (step S101). The facial recognition unit 12 performs the facial recognition based on the image acquired in the step S101 (step S102).

The information processing unit 13 determines whether the registrant identified in the step S102 enters the station A or exits from the station A (step S103). In a case where it is determined in the step S103 that the registrant enters the station A (step S103: Enter), the information processing unit 13 acquires the ticket information linked to the registrant. The information processing unit 13 may then link the acquired ticket information with the information indicating entering the station A and may transmit the linked information to the station server 41. As a result, the registrant having entered the station A may be registered in the entry/exit record 51 (step S104).

In a case where it is determined in the step S103 that the registrant exits from the station A (step S103: Exit), the information processing unit 13 acquires the ticket information linked to the registrant. The information processing unit 13 may then link the acquired ticket information with the information indicating exiting from the station A and may transmit the linked information to the station server 41. As a result, the registrant having exited from the station A may be registered in the entry/exit record 51 (step S105).

As described above, performed in the information processing apparatus 10 is an information processing method including: acquiring an image including a facial recognition area, which is set in a ticket gate area of a railway station and through which a user of the railway station passes; performing facial recognition on the user, based on the image; and registering information for using an automatic ticket gate linked to a registrant corresponding to the user identified by the facial recognition, and information indicating at least one of the user entering the railway station and the user exiting from the railway station, in a system related to the automatic ticket gate.

The aforementioned information processing apparatus 10 may be realized by a computer reading a computer program recorded on a recording medium. In this case, it can be said that a computer program that allows a computer to execute an information processing method is recorded on a recording medium, the information processing method including: acquiring an image including a facial recognition area, which is set in a ticket gate area of a railway station and through which a user of the railway station passes; performing facial recognition on the user, based on the image; and registering information for using an automatic ticket gate linked to a registrant corresponding to the user identified by the facial recognition, and information indicating at least one of the user entering the railway station and the user exiting from the railway station, in a system related to the automatic ticket gate.

### (Technical Effect)

In a case where the information processing apparatus that detects entry to and exit from a railway station via the facial recognition (e.g., the information processing apparatus 10) is introduced at railway stations, it is highly unlikely that the information processing apparatus is simultaneously introduced at all the railway stations. For example, in early stages of introducing the information processing apparatus, the information processing apparatus and the existing system related to the automatic ticket gates may coexist. Consequently, there may arise a situation where the information processing apparatus is installed at one railway station, while only the automatic ticket gates are installed at other stations. If no countermeasures are taken in such a situation, in a case where a user enters using the facial recognition at one railway station and then exits through the automatic ticket gate at another railway station, there is a possibility that railway charges (e.g., fares) cannot be appropriately collected from that user.

The information processing apparatus 10 identifies, for example, at least one of a user entering the station A and a user exiting from the station A through the facial recognition. The information processing apparatus 10 then links the ticket information (e.g., the information about at least one of the IC ticket and the mobile ticket) of the user identified by the facial recognition, with one of the information indicating entering the station A and the information indicating exiting from the station A, and transmits the linked information to the station server 41. As a result, the aforementioned user having entered the station A or having exited from the station A is registered in the entry/exit record 51 on the center server 50. Therefore, it can be said that the information processing apparatus 10 registers the user having entered the station A or having exited from the station A, in the system related to the automatic ticket gates.

Through the above operation of the information processing apparatus 10, the information about entering/exiting from a railway station detected by the facial recognition is integrated with the information about entering/exiting from a railway station detected by the automatic ticket gate. Consequently, even if a user enters using the facial recognition at one railway station and then exits through the automatic ticket gate at another railway station, it is possible to appropriately collect the railway charges (e.g., fares) from that user.

### Second Example Embodiment

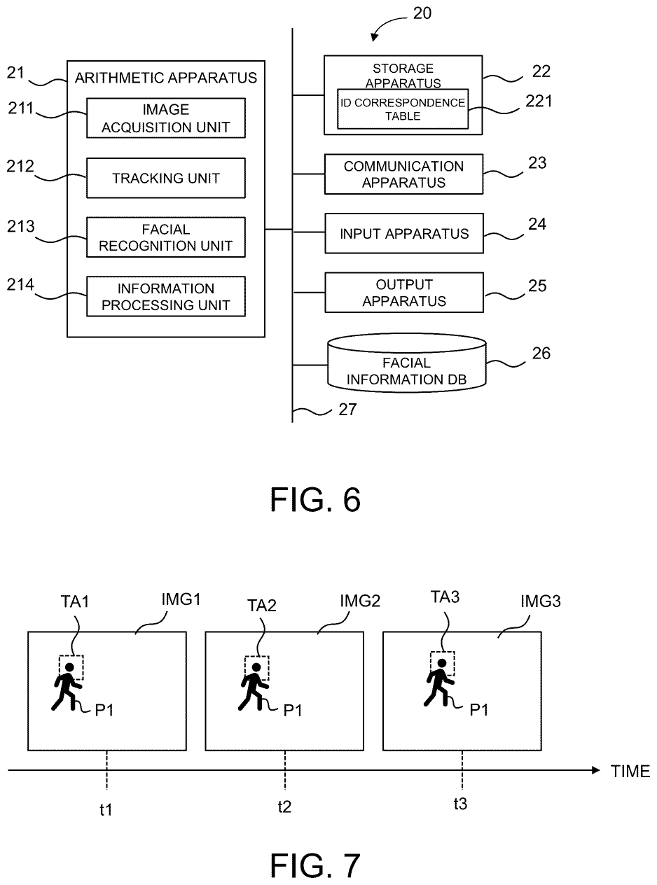

An information processing apparatus, an information processing method, and a recording medium according to a second example embodiment will be described with reference to FIG. 6 to FIG. 8. In the second example embodiment, the ticket gate system 1 may include an information processing apparatus 20, instead of the information processing apparatus 10. The following describes the information processing apparatus, the information processing method, and the recording medium according to the second example embodiment, by using the information processing apparatus 20. In the second example embodiment, a description that overlaps with that of the first example embodiment is omitted as appropriate.

In the second example embodiment, the information processing apparatus 20 may be installed, for example, at the station A. At the station A, the information processing apparatus 20 may be connected to the station server 41 via a narrow area network such as a LAN. Note that an information processing apparatus similar to the information processing apparatus 20 may also be installed, for example, at the station B.

### (Configuration of Information Processing Apparatus)

In FIG. 6, the information processing apparatus 20 includes an arithmetic apparatus 21, a storage apparatus 22, and a communication apparatus 23. The information processing apparatus 20 may further include an input apparatus 24 and an output apparatus 25. The information processing apparatus 20 may include a facial information database 26 (hereinafter referred to as a “facial information DB 26” as appropriate). The information processing apparatus 20 may not include at least one of the input apparatus 24 and the output apparatus 25. In the information processing apparatus 20, the arithmetic apparatus 21, the storage apparatus 22, the communication apparatus 23, the input apparatus 24, the output apparatus 25, and the facial information DB 26 may be connected via a data bus 27.

Incidentally, the facial information DB 26 may store the same information as that registered in the facial information DB 60. The facial information DB 26 may be updated at predetermined intervals to ensure that the information registered in the facial information DB 26 is the same as that registered in the facial information DB 60.

The arithmetic apparatus 21 may include, for example, at least one of a CPU (Central Processing Unit), a GPU (Graphics Processing Unit), a FPGA (Field Programmable Gate Array), a TPU (Tensor Processing Unit), and a quantum processor.

The storage apparatus 22 may include, for example, at least one of a RAM (Random Access Memory), a ROM (Read-Only Memory), a hard disk apparatus, a magneto-optical disk apparatus, a SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program.

The communication apparatus 23 may be configured to communicate with an apparatus external to the information processing apparatus 20. The communication apparatus 23 may perform wired communication or wireless communication.

The input apparatus 24 is an apparatus that is configured to receive an input of information to the information processing apparatus 20 from an external source. The input apparatus 24 may include an operating apparatus (e.g., a keyboard, mouse, touch panel, etc.) that is operable by an operator of the information processing apparatus 20. The input apparatus 24 may include a recording medium reading apparatus that is configured to read information recorded on a recording medium that is attachable to or detachable from the information processing apparatus 20, such as, for example, a USB (Universal Serial Bus) memory. In a case where information is inputted to the information processing apparatus 20 via the communication apparatus 23 (in other words, in a case where the information processing apparatus 20 acquires information via the communication apparatus 23), the communication apparatus 23 may function as an input apparatus.

The output apparatus 25 is an apparatus that is configured to output information to the outside of the information processing apparatus 20. The output apparatus 25 may output visual information such as characters and images, may output auditory information such as voice, or may output tactile information such as vibration, as the above information. The output apparatus 25 may include, for example, at least one of a display, a speaker, a printer, and a vibration motor. The output apparatus 25 may be configured to output information to a recording medium that is attachable to or detachable from the information processing apparatus 20, such as, for example, a USB memory. In a case where the information processing apparatus 20 outputs information via the communication apparatus 23, the communication apparatus 23 may function as an output apparatus.

The arithmetic apparatus 21 may include an image acquisition unit 211, a tracking unit 212, a facial recognition unit 213, and an information processing unit 214, as function blocks realized logically or as processing circuits realized physically.

At least one of the image acquisition unit 211, the tracking unit 212, the facial recognition unit 213, and the information processing unit 214 may be realized in a form in which logical function blocks and physical processing circuits (i.e., hardware) are mixed. In a case where at least a part of the image acquisition unit 211, the tracking unit 212, the facial recognition unit 213, and the information processing unit 214 is a function block, the at least a part of the image acquisition unit 211, the tracking unit 212, the facial recognition unit 213, and the information processing unit 214 may be implemented by the arithmetic apparatus 21 executing a predetermined computer program.

The arithmetic apparatus 21 may acquire (in other words, read) the predetermined computer program from the storage apparatus 22. The arithmetic apparatus 21 may also read the predetermined computer program stored on a computer-readable, non-transitory recording medium, by using a not-illustrated recording medium reading apparatus provided in the information processing apparatus 20. The arithmetic apparatus 21 may acquire (in other words, may download or read) the predetermined computer program from a not-illustrated apparatus external to the information processing apparatus 20 via the communication apparatus 23. As the recording medium that records therein the predetermined computer program to be executed by the arithmetic apparatus 21, at least one of an optical disk, a magnetic medium, a magneto-optical disk, a semiconductor memory, and any other medium configured to store a program may be used.

The “image acquisition unit 211,” the “facial recognition unit 213,” the “information processing unit 214,” and the “facial information DB 26” are components corresponding to the “image acquisition unit 11,” the “facial recognition unit 12,” the “information processing unit 13,” and the “facial information DB 14” described in the first example embodiment above, respectively.

### (Operation of Information Processing Apparatus)

The information processing apparatus 20 performs facial recognition on the authentication subjects (i.e., users of the station A), based on images captured by the camera CAM. The information processing apparatus 20 may perform the facial recognition on the authentication subjects while the authentication subjects are passing through the facial recognition area Ar. That is, the information processing apparatus 20 may be an apparatus that allows walk-through facial recognition.

In a case where the apparatus that is capable of physically preventing the passage of the authentication subjects is not installed in or around the facial recognition area Ar, a facial recognition method performed by the information processing apparatus 20 may be referred to as gate-less facial recognition.

The image acquisition unit 211 acquires an image(s) including the facial recognition area Ar, which is captured by the camera CAM. The tracking unit 212 performs tracking processing on one or more authentication subjects (i.e., users of the station A) passing through the facial recognition area Ar, by using the image(s) acquired by the image acquisition unit 211. Furthermore, the facial recognition unit 213 performs facial recognition processing on one or more authentication subjects passing through the facial recognition area Ar, by using the image(s)acquired by the image acquisition unit 211.

As a specific example of the tracking processing performed by the tracking unit 212, a case where the tracking unit 212 performs the tracking processing on a person P1 who is an authentication subject passing through the facial recognition area Ar will be described with reference to FIG. 7. Furthermore, as a specific example of the facial recognition processing performed by the facial recognition unit 213, a case where the facial recognition unit 213 performs the facial recognition processing on the person P1, who is an authentication subject.

Images IMG1, IMG2, and IMG3 illustrated in FIG. 7 are images including the person P1 corresponding to the aforementioned authentication subject (in other words, images in which the person P1 is captured). Th image IMG1 is an image generated by the camera CAM capturing the facial recognition area Ar at a time t1. The image IMG2 is an image generated by the camera CAM capturing the facial recognition area Ar at a time t2, which is later than the time t1. The image IMG3 is an image generated by the camera CAM capturing the facial recognition area Ar Each of the images IMG1, IMG2, and IMG3 may correspond to a single frame of a video. In this case, the image IMG2 may not correspond to a frame immediately after a frame corresponding to the image IMG1. That is, the image IMG2 may correspond to a frame that is two or more frames later than the frame corresponding to the image IMG1. Similarly, the image IMG3 may not correspond to a frame immediately after the frame corresponding to the image IMG2. That is, the image IMG3 may correspond to a frame that is two or more frames later than the frame corresponding to the image IMG2.

The tracking unit 212 detects, from the image IMG1, a head of the person P1 included in the image IMG1. Since existing techniques/technologies are applicable to a method of detecting a human head from an image, a detailed description of the method is omitted. Based on the detected head of the person P1, the tracking unit 212 sets an area including the head of the person P1 as a tracking area TA1.

In a case where the tracking area TA1 is set, the tracking unit 212 sets or assigns a tracking ID, which is identification information for identifying the person P1 related to the tracking area TA1, to the person P1. The tracking unit 212 calculates a position of the person P1 (e.g., a position at the feet of the person P1) based on the tracking area TA1. Since existing techniques/technologies are applicable to a method of calculating, from an image, the position of a subject included in an image, a detailed description of the method is omitted. The tracking unit 212 links the tracking ID with the position of the person P1 and registers it in an ID correspondence table 221 stored in the storage apparatus 22.

In a case where the tracking area TA1 is set, the tracking unit 212 determines whether or not a face of the person P1 is captured in the tracking area TA1. In other words, the tracking unit 212 performs face detection on the tracking area TA1. In a case where it is determined that the face of the person PI is captured in the tracking area TA1, the tracking unit 212 generates a facial image including a face area of the person P1. The tracking unit 212 links the generated facial image with the tracking ID of the person P1 and transmits it to the facial recognition unit 213. In a case where it is determined that the face of the person P1 is not captured in the tracking area TA1, the tracking unit 212 may not generate a facial image.

The facial recognition unit 213 performs the facial recognition processing by using the facial image transmitted from the tracking unit 212. For example, the facial recognition unit 213 may calculate facial feature quantities indicating the features of the face of the person P1 from the above facial image. The facial recognition unit 213 may calculate a matching score from the calculated facial feature quantities and from facial feature quantities based on the facial information on a single registrant stored in the facial information DB 26.

In a case where the calculated matching score is greater than a predetermined threshold, the facial recognition unit 213 determines that the facial recognition is successful. In this case, a single registrant corresponding to a person (here, the person P1) indicated by the facial image transmitted from the tracking unit 212 is identified from among a plurality of registrants registered in the facial information DB 26. On the other hand, in a case where the calculated matching score is less than the predetermined threshold, the facial recognition unit 213 determines that the facial recognition is failed. In this case, it is highly likely that a person corresponding to the person (here, the person P1) indicated by the facial image transmitted from the tracking unit 212 is not registered in the facial information DB 26. In a case where the calculated matching score is “equal” to the predetermined threshold, it may be included in one of the cases.

In a case where the facial recognition is successful, the facial recognition unit 213 links the authentication ID indicating the registrant registered in the facial information DB 26 corresponding to the person (here, the person P1) indicated by the facial image transmitted from the tracking unit 212, to the tracking ID linked to the facial image described above, and registers it in the ID correspondence table 221. In addition to the authentication ID, the facial recognition unit 213 may register an authentication time, which is a time at which the facial recognition processing is performed, in the ID correspondence table 221. In a case where the facial recognition is failed, the facial recognition unit 213 may link information indicating that there is no matching person (e.g., “N/A (Not Applicable)”) to the tracking ID linked to the facial image transmitted from the tracking unit 212, and may register it in the ID correspondence table 221.

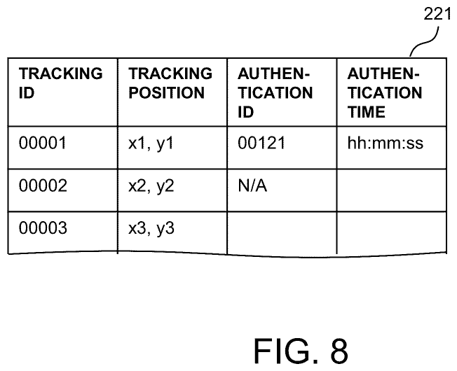

With reference to FIG. 8, the ID correspondence table 221 will be described. As illustrated in FIG. 8, the tracking ID, the tracking position (e.g., the position at the feet of the person P1), the authentication ID, and the authentication time are linked with each other in the ID correspondence table 221. In a case where the tracking ID is linked with a specific authentication ID in the ID correspondence table 221, it indicates that a registrant corresponding to a person for whom the tracking ID is set is registered in the facial information DB 26. In a case where the tracking ID is linked with the character string “N/A”, it indicates that a person corresponding to the person for whom the tracking ID is set is not registered in the facial information DB 26. In a case where the tracking ID is not linked with the authentication ID (i.e., in a case where a field of the authentication ID is blank), it indicates that the facial recognition processing has never been performed.

The tracking unit 212 may identify the person P1 included in the image IMG2, by using the image IMG2 and the image IMG1. Identifying the person P1 included in the image IMG2 is synonymous with establishing correspondence/mapping between the person P1 included in the image IMG1 and the person P1 included in the image IMG2. Therefore, at least one of a matching method and an optical flow method associated with the correspondence/mapping between images, is applicable to the identification of the person P1 included in the image IMG2. Since existing various aspects are applicable to each of the matching method and the optical flow method, a detailed description of each method is omitted.

In a case where the person P1 included in the image IMG2 is identified, the tracking unit 212 detects the head of the person P1. Based on the detected head of the person P1, the tracking unit 212 sets an area including the head of the person P1 as a tracking area TA2. Since the person P1 included in the image IMG1 and the person P1 included in the image IMG2 are the same person, the tracking ID of the person P1 related to the tracking area TA2 is the same as the tracking ID of the person P1 related to the tracking area TA1. The tracking unit 212 calculates the position of the person P1 based on the tracking area TA2.

The tracking unit 212 links the position of the person P1 to the tracking ID of the person P1 and registers it in the ID correspondence table 221. In this case, since the position of the person P1 calculated based on the tracking area TA1 is registered in the ID correspondence table 221, the position of the person P1 is updated by the tracking unit 212 registering the position of the person P1 calculated based on the tracking area TA2, in the ID correspondence table 221.

In a case where the tracking area TA2 is set, the tracking unit 212 determines whether or not the face of the person P1 is captured in the tracking area TA2. In other words, the tracking unit 212 performs the face detection on the tracking area TA2. In a case where it is determined that the face of the person P1 is captured in the tracking area TA2, the tracking unit 212 generates a facial image including the face area of the person P1. The tracking unit 212 links the generated facial image with the tracking ID of the person P1 and transmits it to the facial recognition unit 213. In a case where it is determined that the face of the person P1 is not captured in the tracking area TA2, the tracking unit 212 may not generate a facial image. Even when it is determined that the face of the person P1 is captured in the tracking area TA2, in a case where the tracking ID of the person P1 is linked with the authentication ID in the ID correspondence table 221 (i.e., in a case where the facial recognition is already successful), the tracking unit 212 may not generate a facial image.

The facial recognition unit 213 performs the facial recognition processing by using the facial image transmitted from the tracking unit 212. In a case where the facial recognition is successful, the facial recognition unit 213 links the authentication ID indicating the registrant registered in the facial information DB 26 corresponding to the person (here, the person P1) indicated by the facial image transmitted from the tracking unit 212, to the tracking ID linked to the facial image described above, and registers it in the ID correspondence table 221. In addition to the authentication ID, the facial recognition unit 213 may register the authentication time, which is a time at which the facial recognition processing is performed, in the ID correspondence table 221. In a case where the authentication time is already registered in the ID correspondence table 221 (i.e., in a case where the facial recognition was successful in the past), the facial recognition unit 213 may update the authentication time registered in the ID correspondence table 221. In a case where the facial recognition is failed, the facial recognition unit 213 may link the information indicating that there is no matching person (e.g., “N/A”) to the tracking ID linked to the facial image transmitted from the tracking unit 212, and may register it in the ID correspondence table 221.

The tracking unit 212 may identify the person P1 included in the image IMG3 by using the image IMG3 and the image IMG2. In a case where the person P1 included in the image IMG3 is identified, the tracking unit 212 detects the head of the person P1. Based on the detected head of the person P1, the tracking unit 212 sets an area including the head of the person P1 as a tracking area TA3. Since the person P1 included in the image IMG2 and the person P1 included in the image IMG3 are the same person, the tracking ID of the person P1 related to the tracking area TA3 is the same as the tracking ID of the person P1 related to the tracking area TA2. The tracking unit 212 calculates the position of the person P1 based on the tracking area TA3.

The tracking unit 212 links the position of the person P1 to the tracking ID of the person P1 and registers it in the ID correspondence table 221. In this case, since the position of the person P1 calculated based on tracking area TA2 is registered in the ID correspondence table 221, the position of the person P1 is updated by the tracking unit 212 registering the position of the person P1 calculated based on tracking area TA3, in the ID correspondence table 221.

In a case where the tracking area TA3 is set, the tracking unit 212 determines whether or not the face of the person P1 is captured in the tracking area TA3. In other words, the tracking unit 212 performs the face detection on the tracking area TA3. In a case where it is determined that the face of the person P1 is captured in the tracking area TA3, the tracking unit 212 generates a facial image including the face area of the person P1. The tracking unit 212 links the generated facial image with the tracking ID of the person P1 and transmits it to the facial recognition unit 213. In a case where it is determined that the face of the person P1 is not captured in the tracking area TA3, the tracking unit 212 may not generate a facial image. Even when it is determined that the face of the person P1 is captured in the tracking area TA3, in a case where the tracking ID of the person P1 is linked with the authentication ID in the ID correspondence table 221 (i.e., in a case where the facial recognition is already successful), the tracking unit 212 may not generate a facial image.

The facial recognition unit 213 performs the facial recognition processing by using the facial image transmitted from the tracking unit 212. In a case where the facial recognition is successful, the facial recognition unit 213 links the authentication ID indicating the registrant registered in the facial information DB 26 corresponding to the person (here, the person P1) indicated by the facial image transmitted from the tracking unit 212, with the tracking ID linked with the facial image described above, and registers it in the ID correspondence table 221. In addition to the authentication ID, the facial recognition unit 213 may register the authentication time, which is a time at which the facial recognition processing is performed, in the ID correspondence table 221. In a case where the authentication time is already registered in the ID correspondence table 221 (i.e., in a case where the facial recognition was successful in the past), the facial recognition unit 213 may update the authentication time registered in the ID correspondence table 221. In a case where the facial recognition is failed, the facial recognition unit 213 may link the information indicating that there is no matching person (e.g., “N/A”) to the tracking ID linked to the facial image transmitted from the tracking unit 212, and may register it in the ID correspondence table 221.

By the way, it may be difficult for the tracking unit 212 to continue tracking the person P1 due to the head of the person P1 being hidden by another person, for example. In a case where the tracking of the person P1 is interrupted, the tracking unit 212 may perform the following processing. After the tracking of the person P1 is interrupted, the tracking unit 212 may determine whether or not a new person is detected from the image acquired by the image acquisition unit 211 (e.g., the image captured by the camera CAM). The “new person” means a person for whom the tracking ID is not set.

In a case where a new person is detected, the tracking unit 212 may determine whether or not the person P1 and the new person are the same person by comparing the feature quantities of the tracking area related to the person P1 (e.g., at least one of the tracking areas TA1, TA2, and TA3) with the feature quantities of the tracking area related to the new person. In a case where it is determined that the person P1 and the new person are the same person, the tracking unit 212 may set the tracking ID of the person P1 for the new person. As a result, the tracking unit 212 is allowed to track the person P1 again.

The feature quantities may be feature quantities related to the head of a person, feature quantities related to an upper body of the person, or feature quantities related to an entire body of the person. That is, the tracking area (e.g., at least one of the tracking areas TA1, TA2, and TA3) may include the head of the person, the upper body of the person, or the entire body of the person. The feature quantities may be obtained, for example, by using a Person Re-Identification technology.

The tracking unit 212 and the facial recognition unit 213 may repeat the aforementioned processing until the person P1 passes through the facial recognition area Ar. The tracking unit 212 and the facial recognition unit 213 may perform the aforementioned processing on all the authentication subjects passing through the facial recognition area Ar.

In the facial recognition area Ar, a first predetermined position and a second predetermined position may be set. The first predetermined position may be set outside the station A in the facial recognition area Ar, relative to the second predetermined position. In other words, the second predetermined position may be set inside the station A in the facial recognition area Ar, relative to the first predetermined position.

The ID correspondence table 221 may include a history of tracking positions linked to each authentication ID. For example, based on the history of tracking positions, the information processing unit 214 may determine that a registrant passing through the first predetermined position followed by the second predetermined position in the facial recognition area Ar is a registrant having entered the station A. For example, based on the history of tracking positions, the information processing unit 214 may determine that a registrant passing through the second predetermined position followed by the first predetermined position in the facial recognition area Ar is a registrant having exitted from the station A.

The information processing unit 214 acquires the ticket information linked to the authentication ID of the registrant corresponding to the authentication subject (e.g., the person P1) identified by the facial recognition unit 213 performing the facial recognition, based on the ID correspondence table 221 and the facial information DB 26.

In a case where the aforementioned registrant corresponds to the authentication subject having entered the station A, the information processing unit 214 may link the ticket information (e.g., the information about at least one of the IC ticket and the mobile ticket) with the information indicating entering the station A and may transmit the linked information to the station server 41. The station server 41 may transmit the ticket information and the information indicating entering the station A, which are transmitted from the information processing unit 214, to the center server 50. As a result, the aforementioned registrant having entered the station A may be registered in the entry/exit record 51.

In a case where the aforementioned registrant corresponds to the authentication subject having exited from the station A, the information processing unit 214 may link the ticket information (e.g., the information about at least one of the IC ticket and the mobile ticket) with the information indicating exiting from the station A and may transmit the linked information to the station server 41. The station server 41 may transmit the ticket information and the information indicating exiting from the station A, which are transmitted from the information processing unit 214, to the center server 50. As a result, the aforementioned registrant having exited from the station A may be registered in the entry/exit record 51.

### (Technical Effect)

According to the information processing apparatus 20, as in the information processing apparatus 10 according to the first example embodiment described above, even if a user enters using the facial recognition at one railway station and then exits through the automatic ticket gate at another railway station, it is possible to appropriately collect the railway charges (e.g., fares) from that user.

### Supplementary Notes

With respect to the example embodiment described above, the following Supplementary Notes are further disclosed.

### (Supplementary Note 1)

An information processing apparatus including:
an image acquisition unit that acquires an image including a facial recognition area, which is set in a ticket gate area of a railway station and through which a user of the railway station passes;
a facial recognition unit that performs facial recognition on the user, based on the image; and
an information processing unit that registers information for using an automatic ticket gate linked to a registrant corresponding to the user identified by the facial recognition, and information indicating at least one of the user entering the railway station and the user exiting from the railway station, in a system related to the automatic ticket gate.

### (Supplementary Note 2)

The information processing apparatus according to Supplementary Note 1, wherein
the information processing apparatus further comprises a tracking unit that tracks the user, based on the image, and
the facial recognition unit performs facial recognition on the user, while the tracking unit is tracking the user.

### (Supplementary Note 3)

The information processing apparatus according to Supplementary Note 1 or 2, wherein the information for using the automatic ticket gate is information about at least one of an IC ticket and a mobile ticket.

### (Supplementary Note 4)

An information processing method including:
acquiring an image including a facial recognition area, which is set in a ticket gate area of a railway station and through which a user of the railway station passes;
performing facial recognition on the user, based on the image; and
registering information for using an automatic ticket gate linked to a registrant corresponding to the user identified by the facial recognition, and information indicating at least one of the user entering the railway station and the user exiting from the railway station, in a system related to the automatic ticket gate.

### (Supplementary Note 5)

A recording medium on which a computer program that allows a computer to execute an information processing method is recorded, the information processing method including:
acquiring an image including a facial recognition area, which is set in a ticket gate area of a railway station and through which a user of the railway station passes;
performing facial recognition on the user, based on the image; and
registering information for using an automatic ticket gate linked to a registrant corresponding to the user identified by the facial recognition, and information indicating at least one of the user entering the railway station and the user exiting from the railway station, in a system related to the automatic ticket gate.

The present disclosure is permitted to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1 Ticket gate system
10, 20 Information processing apparatus
11, 211 Image acquisition unit
12, 213 Facial recognition unit
13, 214 Information processing unit
14, 26, 60 Facial information database

What is claimed is:

1. An information processing apparatus comprising:
at least one memory configured to store instructions; and
at least one processor configured to execute the instructions to:
acquire an image including a facial recognition area, which is set in a ticket gate area of a railway station and through which a user of the railway station pass;
perform facial recognition on the user, using the image, and facial information of registrants wishing to use a system related to an automatic ticket gate, wherein the information of registrants is stored in a storage unit in advance; and
register information for using the automatic ticket gate linked to a registrant corresponding to the user identified by the facial recognition, and information indicating at least one of the user entering the railway station and the user exiting from the railway station, in the system related to the automatic ticket gate.

2. The information processing apparatus according to claim 1, wherein the at least one processor is configured to execute the instructions to:
the user, based on the image; and
perform facial recognition on the user, while tracking the user.

3. The information processing apparatus according to claim 1, wherein the information for using the automatic ticket gate is information about at least one of an IC ticket and a mobile ticket.

4. An information processing method comprising:
acquiring an image including a facial recognition area, which is set in a ticket gate area of a railway station and through which a user of the railway station pass;
performing facial recognition on the user, using the image, and facial information of registrants wishing to use a system related to an automatic ticket gate, wherein the information of registrants is stored in a storage unit in advance; and
registering information for using the automatic ticket gate linked to a registrant corresponding to the user identified by the facial recognition, and information indicating at least one of the user entering the railway station and the user exiting from the railway station, in the system related to the automatic ticket gate.

5. A non-transitory recording medium on which a computer program that allows a computer to execute an information processing method is recorded, the information processing method including:
acquiring an image including a facial recognition area, which is set in a ticket gate area of a railway station and through which a user of the railway station pass;
performing facial recognition on the user, using the image, and facial information of registrants wishing to use a system related to an automatic ticket gate, wherein the information of registrants is stored in a storage unit in advance; and
registering information for using the automatic ticket gate linked to a registrant corresponding to the user identified by the facial recognition, and information indicating at least one of the user entering the railway station and the user exiting from the railway station, in the system related to the automatic ticket gate.
